(19) United States
(12) Patent Application Publication
(10) Pub. No.: US 2008/0229902 A1
(43) Pub. Date: Sep. 25, 2008

(54) ELECTRONIC PERCUSSION INSTRUMENT STAND

(75) Inventors: Yoshiaki Mori, Hamamatsu-city (JP); Koichi Nakao, Hamamatsu-city (JP)

Correspondence Address: FOLEY & LARDNER, 2029 CENTURY PARK EAST, SUITE 3500, LOS ANGELES, CA, 90067, US

(73) Assignee: Roland Corporation

(21) Appl. No.: 12/016,164

(22) Filed: Jan. 17, 2008

(30) Foreign Application Priority Data
Mar. 20, 2007 (JP) 2007-072806

(51) Int. Cl. G10D 13/02

(52) U.S. Cl. 84/421

(57) ABSTRACT

An electronic percussion instrument stand includes a center pipe structure. The center pipe structure has at least one center pipe having a longitudinal axis. A center pipe structure with at least two center pipes provides increased stability. A crescent-shaped base structure supports the center pipe structure in an upright orientation. At least one first arm supports at least one electronic percussion instrument. At least one first joint connects first arm to the center pipe structure. Each joint is adjustable in a direction of the longitudinal axis of the center pipe and in a direction around the longitudinal axis of the center pipe, for adjusting the position of the first arm. Each joint is adjustable between a position for playing electronic percussion instruments supported on the at least one arm, to a retracted position for transportation.

### CROSS-REFERENCE TO RELATED PATENT APPLICATIONS

Priority Application 2007-072806, filed Mar. 20, 2007 including the specification, drawings, claims and abstract, is incorporated herein by reference in its entirety.

### BACKGROUND OF THE DISCLOSURE

1. Field Of The Invention

Embodiments of the present invention relate to an electronic percussion instrument stand and particular embodiments relate to a professional level electronic percussion stand which is easy to adjust with a great amount of adaptability and possible settings.

2. Background

An instrument stand described in Japanese Patent Publication No. 2006-259193 is intended for musicians for use with electronic percussion instruments, including but not limited to electronic cymbals, electronic drums, electronic bass drums, foot pedals and any other components typically found in a musicians percussion drum set. Within an electronic drum set the electronic drums as well as the electronic cymbals are attached to a stand structure, and depending on the preference of the individual artist, the bass drum and foot pedals can also be arranged within the stand architecture.

A standard setup for an electronic drum set may have the electronic drum and the electronic cymbals arrayed along a stand assembly framework with L shaped supporting tubing. In many cases, the tubing used was nearly identical to water flow type pipes. While previous electronic drum and electronic cymbal setups have used water type pipes and L formations, embodiments of the present invention provide an alternative choice and a capability to select favorite settings.

It has been observed that when breaking down and transporting a typical, existing standard electronic drum set having both electronic drum components and electronic cymbal components on an L shaped water pipe, can be both cumbersome and heavy and a great burden to move, particularly when the drum set includes a base drum. In order to break down and transport a stand assembly of typical prior designs, it was necessary to separate the electronic drums and the electronic cymbals from the stand assembly and then reassemble the entire structure again later in order to play. With each re-assembly, the setting must be recalibrated for the electronic drum and electronic cymbal, which can cause a great deal of lost time and effort as well as frustration on the part of the musician.

Also, for storing such typical stand structures, the electronic drums and electronic cymbals must be removed from the stand and stored separately from the stand, which can require additional effort to transport the components and store the bulky piping of the stand assembly structure. The act of disassembly of the pipe stand assembly as well as the act of removing the electronic drums and electronic cymbals can require a significant effort. The necessity to disassemble, move, reassemble and reset can be a very time consuming process, particularly the re positioning of the electronic instruments to the artists satisfaction upon reassembly.

Embodiments of the present invention may be configured to minimize these problems and inconveniences. Embodiments of the present invention provide an electronic percussion instrument stand which is simple to disassemble, transport, reassemble and adjust to the artist's satisfaction.

### SUMMARY OF THE DISCLOSURE

Accordingly, a first embodiment of the present invention relates to an electronic percussion instrument stand design which allows the artist an improved pipe structure for a stand assembly, including a double arm system with a single base and a counterbalanced axis system that provides the artist with flexibility and access to an optional additional playing platform.

A second embodiment of the electronic percussion instrument stand relates to features of the base portion of the stand and multiple connection ports on both sides of the base and the ability of the base to support the arm segments at any one of a plurality of multiple settings along various axis lines. Opposing center pipes are designed to give maximum flexibility while still providing the base with the ability to provide the entire structure maximum stability even under the most extreme adjustments of the arm segments.

A third embodiment relates to features of the second embodiment. In its first primary setting, a stand structure according to the first embodiment is able to be adjusted along multiple axes by shifting the pipe structures. The center pipes are capable of being connected to multiple connecting arms through first and second joint structures, while the base structure is also able to be connected to the center pipe structure and aligned while maintaining support for the overall stability of the stand apparatus.

Improved functionality can be provided by employing a half rounded (generally semi-circular or “C” shape form) form of the base and its ability to maintain stability and functionality in virtually any configuration. In addition, embodiments with the half rounded (generally semi-circular or “C” shaped) base can provide the above-mentioned support capabilities with a relatively light weight structure.

A fourth embodiment relates to the second or third embodiments wherein the base component is shaped in a half rounded (or generally semi circular form) to increase stability and decrease weight. In addition, the arm structure is connected to the center pipe structure that extends from a central point of the base. Electronic percussion instruments as well as accessories are attached to the arm structure and the center pipe structure.

A fifth embodiment relates to the first, second, third or fourth embodiments, wherein the pipe structure is divided into two separate pipe units. Each of these separate pipe units is independently capable of joining with the various instruments which may be attached to this stand structure. When attached to a first pipe unit, each arm is also capable of independent free motion to place it in a virtually unlimited number of positions.

A sixth embodiment of an electronic percussion instrument stand apparatus includes hollow portions of the stand apparatus and relates to how they connect with the interior sections of the axis shaft. The pipe structure is connected in a manner in which a hollow core of the connected tubing pipes extend contiguously throughout the pipe structure from the base unit, up through the arms and outside to a musical instrument attachment point. In the event of change adjustment of configuration, the connected hollow interior paths would still run from the center through the structure of the stand out to the musical instrument connection point, through a first sidewall structure. When the configuration of a stand structure according to an embodiment of the present invention is adjusted to a near perpendicular stance, then the hollow portion of the interior of the shaft structure would run instead extend through a second sidewall structure to the musical instrument connection point.

In the above mentioned first embodiment of an electronic percussion instrument stand, when the pipe structure is in a vertical configuration, the musician can very efficiently strike at percussion instruments attached to the instrument attachment points along the arms. In this vertical setting, the base plate structure is directly connected to the arm components. In this way the base structure can very effectively handle the pressure applied not just from the instruments themselves but also from the repeated vigorous striking of the instruments by the artist, as well as provide support and stability to the second arm structure which allows the artist to connect still further instruments to a second instrument connecting point. Thus, a second separate stand structure is not required and, instead, an artist may assemble and position further instruments on the second arm structure at the second instrument connection point, all within a single stand structure. This combination of features and flexibility available with an electronic percussion instrument stand according to embodiments of the present invention can significantly reduce the amount of time required for setup and adjustment of the attached instruments. The second arm structure may be attached to the central pipe structure as well as the base as part of a single unit. Thus, the second instrument connecting point, being part of the single unit, will not require separate handling or assembly. As a result, the structure can be relatively easy to carry, assemble, and adjust.

With the electronic percussion stand unit adjusted in its vertical setting the artist will generally utilize a first instrument connection point for a primary percussion instrument. The design involved in the arm shaft piping can provide significant improvements over water type pipes, including providing the artist substantial flexibility in adjusting instrument positions.

In addition to features described above concerning the first and second embodiments of an instrument stand, the base structure may be connected to legs as well as the two arm structures. The arm structures and leg structures are connected to the base structure on either side of the axis of the base structure. Also because the arm structure, when placed in a vertical setting, is connected to the base via its vertical shaft pipe, the arm may be easily adaptable to multiple positions. Because the leg structures are connected to the base, on both sides of the base, the leg structures extend outward and, if left in that configuration, can become inconvenient when the electronic percussion instrument stand is to be transported. However, the leg structure is designed to fold back into the primary stand structure (when the piping structure collapses vertically into the primary stand structure) to reposition the leg structures out of the way.

The electronic percussion instrument stand structure according to the second and third embodiments relates to the structure described in connection with the first embodiment. In addition, the shaft ends are received into the interior of the shaft axis. Also, when positioned vertically the second joint and the base are aligned to set the stand structure in a linear, easily transportable position. When set in this position with the arm shafts vertical and the first and second base joints aligned as well as the legs retracted, the stand becomes easily transportable as well as easily adjusted from this configuration upon re set up. When the first and second arms are, along with the first and second joints, positioned as described above, the structure of this stand can be easy to move and reposition.

A fourth embodiment of an electronic percussion instrument stand includes features described above for the second or third embodiments. In addition, in the fourth embodiment, the base segment of the stand is half rounded or in the shape of a semi-circle or flattened crescent (or “C” shape). Also, the arm pipe and the coupling joints are attached via edge connectors to a central portion of the base plate structure. In addition the base plate structure has, on both sides of it, a coupling for the leg structures which support the stand apparatus and are capable of folding back against the base plate structure. The leg structures also support the second arm structure, including the second musical instrument connecting point, from their central location. In this way, the artist has the ability to shift the second musical instrument connecting point to multiple positions from which to more easily play. Without the ability to shift the second musical instrument connecting point, the artist may find it more difficult to position the instruments to a desired play position. However, with embodiments of the present invention, the artist has virtually total control over the positioning of the instruments and thus is more easily able to move the instruments to the artist's satisfaction for more efficiently play.

According to a fifth embodiment, the pipe units are constructed from 2 conjoined pipe sections, where one of these pipe sections is joined by an end connector. Also because each arm structure is composed of 2 conjoined pipe units, the artist is able to attach a musical instrument to the first musical instrument connector and adjust it to the artist's specifications, even vertically. The first musical instrument connector and the flexibility to use one or both of the arm structures gives the artist further freedom to, when playing music, adjust the attitude and pitch of the instrument on the stand.

Also when installing an instrument on the first musical instrument connection point, it is possible to use the structure with minimal risk of structural collapse or a need for counterbalance, because the pipe structure of the arm is such that both ends are equally strong and able to support weight. Also, the strength of the components may be selected such that the artist can easily move the instruments around even once they are installed on the stand. This includes adjusting of height, pitch, and attitude. This also includes the ability to easily, verticality adjust the position of the various components.

According to the sixth embodiment, in the event that the first musical instrument connection point is positioned in a vertical position, the arm connection joints utilize the internal hollow pipe interior to allow flow between the base areas and the first musical instrument connection point, through the hollow interior of the tubing. In the event of a large horizontal shifting of components and the arm structure, the hollow connection from the base to the first instrument connection point will be maintained through a second side wall connection. Thus the option exists of either utilizing a first side wall mount or a second side wall mount to maintain a flow through, thus during the transport and set up phase it is possible to choose between a wide number of options for place of necessary components within the flexible structure of this stand, especially to the first musical instrument connection point. Accordingly, transporting and setting up of the stand can be very simplified.

Various non-limiting embodiments of the invention are described below, utilizing illustrations of FIGS. 1-5. With reference to the illustration of FIG. 1 an explanation is provided regarding a way in which an electronic percussion stand unit 10 can be utilized with an electronic percussion system 1. FIG. 1 shows a perspective view of an embodiment of the invention, from an external perspective.

### BRIEF DESCRIPTION OF THE DRAWINGS

FIG. 1 is a perspective view of an electronic percussion instrument and stand system according to an embodiment of the present invention;

FIG. 2 is a rear view of a portion of the electronic percussion instrument stand of the system of FIG. 1;

FIGS. 3(a-1) to 3(c-2) illustrate installation components and a center pipe according to an embodiment of the present invention;

FIG. 4 illustrates an embodiment of a base structure and its connection with other components;

FIG. 5 is a perspective view illustrating an electronic percussion instrument system in a collapsed or folded orientation, for example, ready for transport.

### DETAILED DESCRIPTION OF PREFERRED EMBODIMENTS

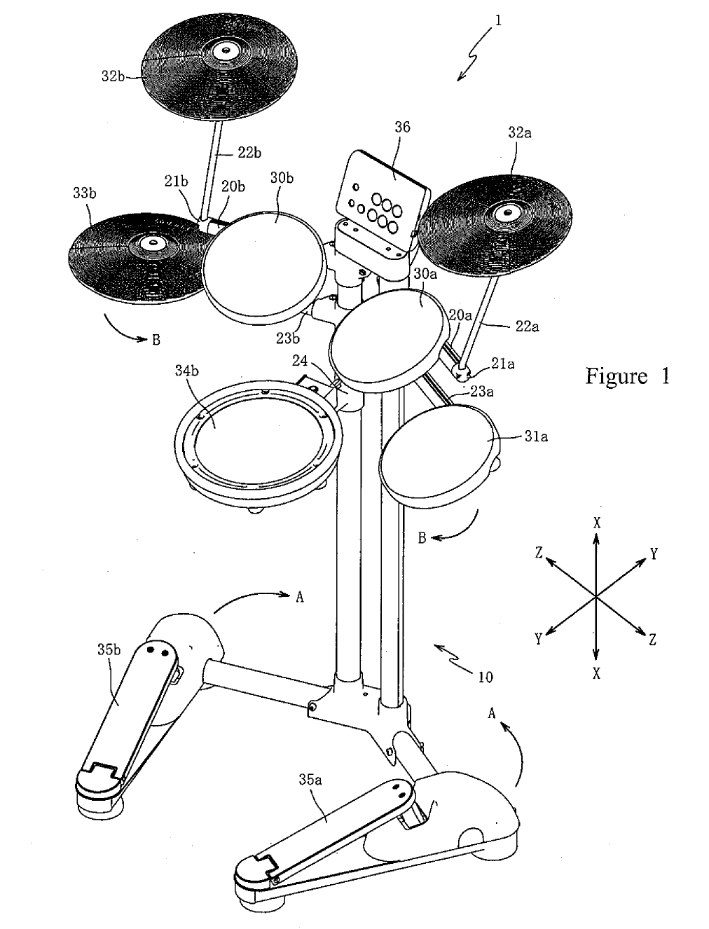

Various aspects of embodiments of the present invention are discussed below with reference to illustrations of FIGS. 1-5. With reference to FIG. 1, an explanation is provided regarding a way in which an electronic percussion instrument stand 10 can be used in an electronic percussion system 1. FIG. 1 shows a perspective view of an embodiment of the invention, from an external perspective.

In FIG. 1, the arrow X refers to a vertical direction, relative to the normal orientation of the electronic percussion instrument system 1 (and electronic percussion instrument stand 10), while the arrow Y shows a direction from the front to the back of the electronic percussion instrument system 1 (and electronic percussion instrument stand 10) and the arrow Z shows the left-right direction of the electronic percussion instrument system 1 (and electronic percussion instrument stand 10). Also arrows A and B show adjustment directions for the electronic percussion instrument system 1.

As shown in FIG. 1 the electronic percussion instrument system 1 may include one or more of the following components attached to the electronic percussion instrument stand 10 which may be utilized by an artist to strike and make music: drum pads 30a, 30b, 31a, cymbal pads 32a, 32b, high hat cymbal 33b, snare pad 34b, foot pedals 35a, 35b, and a the sound source processor or controller 36. In further embodiments, other suitable components may be included in the electronic percussion instrument system 1.

Because such components as the drum pads 30a, 30b, 31a, cymbal pads 32a, 32b, high hat cymbal 33b, snare pad 34b, and the foot petals 35a, 35b may be common and well known elements of a typical percussion instrument set, further explanation of each those component is not provided herein. The controller or sound source 36 may be a component which receives electronic input signals (input signals based on the frequency and strength of each strike upon the pad and step on the foot petal) from the components drum pads 30a, 30b, 31a, cymbal pads 32a, 32b, high hat cymbal 33b, snare pad 34b, and the foot petals 35a, 35b and provides electronic signals for generating audio sounds through other components such as speakers and other electronic output components (not shown).

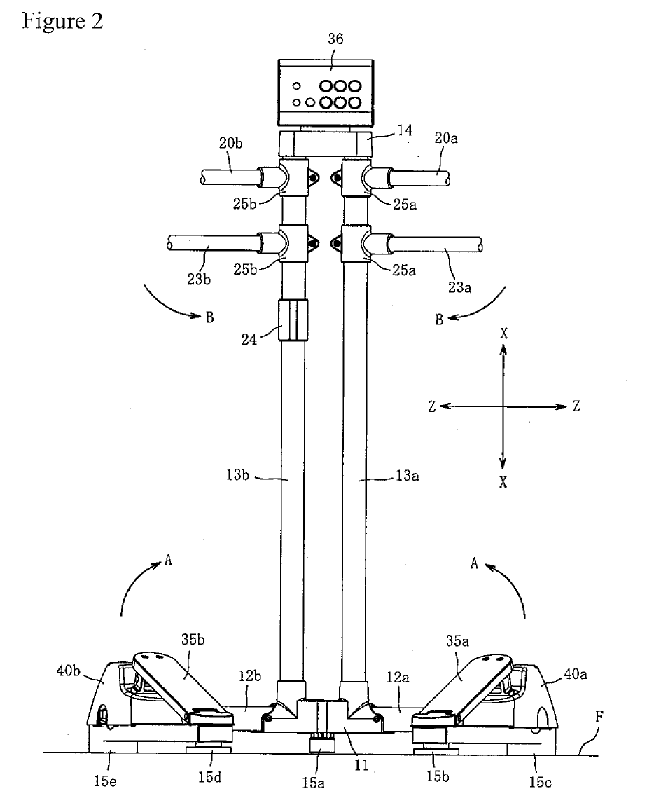

The drum pad 30a is connected to a center pipe 13a (see FIG. 2) by the arm pipe 20a. Cymbal pad 32a is joined with the arm pipe 20a via the end of a coupling member 21a and held vertically above the arm pipe 20a (in the direction X in FIG. 2) and supported by a stabilizing rod 22a. Also the drum pad 31a is supported by the center pipe 13a, through the arm pipe 23a.

The drum pad 30b is connected to a center pipe 13b by the arm pipe 20b (see FIG. 2). Cymbal part 32b is joined with the arm pipe 20b via an end of the coupling member 21b and held vertically above the arm pipe 20b (in the direction X in FIG. 2) and supported by the stabilizing rod 22a. Also the high hat cymbal 33b is connected to the center pipe 13b by the arm pipe 23b. The snare pad 34b is attached to the center pipe 13b via the joint component 24.

The foot petals 35a and 35b are attached to the lower portions of the electronic percussion instrument stand 10 (see the lower portion of FIGS. 1 and 2) and are positioned on the player's side of the electronic percussion instrument stand 10.

FIG. 2 is a diagram showing various directions of positioning of the electronic percussion instrument stand 10. In FIG. 2, the instruments and other components upon which an artist produces music are not shown.

In FIG. 2, the electronic percussion instrument stand 10 has a base structure 11 that is set on a flat surface F. Extending at least partially in the directions of arrows Z from the base structure 11 is attached a leg pipe 12a and a leg pipe 12b. A leg component 40a (supporting the foot pedal 35a) is attached to the leg pipe 12a and a leg component 40b (supporting the foot pedal 35b) is attached to the leg pipe 12b. Also attached and extending vertically (in the direction of arrow X) from the base structure 11 is a center pipe structure composed of center pipes 13a and 13b. The controller component 36 is attached to the center pipe structure through a holder 14.

Attached to the center pipe 13a are two joint components 25a for attaching the arm pipes 20a and 23a, respectively, to the center pipe 13a. Also a joint component 24 is attached to the center pipe 13b, and two further joint components 25b attached arm pipes 20b and 23b, respectively, to the center pipe 13b. The joint components 25a, 25b and 24 may have a similar structure.

The joint components 25a, 25b, and 24 may be configured to always be connected to the center pipes 13a and 13b and the grip with which these components hold onto the center pipes is adjusted via a screw (such as a manually operable set screw or the like, not shown in the drawing). Also the vertical positioning of the joint components 25a, 25b, and 24 (see FIG. 2, arrow X) along the center pipes 13a and 13b can be altered easily and quickly.

The center pipes 13a and 13b are parallel to each other and can be arranged horizontally, closer or further apart from each other. By minimizing the distance between the two center pipes 13a and 13b, the electronic percussion stand 10 can take on a more compact configuration for easier transportation (see FIG. 2 arrow Z). In order to allow for ease of collapse of the electronic percussion stand assembly, each of the joint components 25a, 25b, and 24, once released, may rotate around the axis of one of the center pipes 13a and 13b and thus allow the electronic percussion instrument stand to collapse in on itself making it more compact and portable.

Attached to the underside of the base 11 is a pedestal 15a for resting on the surface F. Attached to the underside of the leg component 40a are pedestals 15b and 15c for resting on the surface F. Similarly, attached to the underside of the leg component 40b are pedestals 15d and 15e for resting on the surface F. The entire electronic percussion instrument stand assembly is supported by the pedestals 15a-e on the surface F. At the same time the base 11 as well as the leg components 40a and 40b are stabilized and bold the center pipes 13a and 13b vertical (in the direction X).

Also as shown in FIG. 2, the leg components 40a and 40b are connected to pipes 12a and 12b, while the pipes 12a and 12b are connected to the base unit 11 (at the center of the base unit) where the components all meet. Also as shown in FIG. 1, the base 11 is held with its crescent shape arranged horizontal along the surface F. The pedestals 15a-e are arranged around the base unit 11 and legs 40a and 40b, in a configuration, such as, but not limited to a general pentagon shape, for providing a high degree of stability for the entire electronic percussion instrument stand assembly 10.

The leg components 40a and 40b are connected to the ends of the pipes 12a and 12b and extend away from the base unit 11, which allows the leg components that support the artist's foot pedals 35a and 35b to be positioned away from (to the sides of, in the Z direction) the primary assembly and allows the artist much easier access to the pedal. Thus the artist is able to depress the foot pedals 35a and 35b with ease and minimal wasted motion.

While the leg components 40a and 40b may be attached to the pipe units 12a and 12b, the leg components 40a and 40b are movable so that the position and attitude of the leg components 40a and 40b may be shifted as per the artist's desire. This is aided by the length of pipes 12a and 12b as well as by the size of leg components 40a and 40b. In one embodiment, the pipe units 12a and 12b have a nearly 30 degree range of motion in the direction of arrow A with which to be adjusted for ease of use. Other embodiments may be configured to provide other suitable ranges of motion.

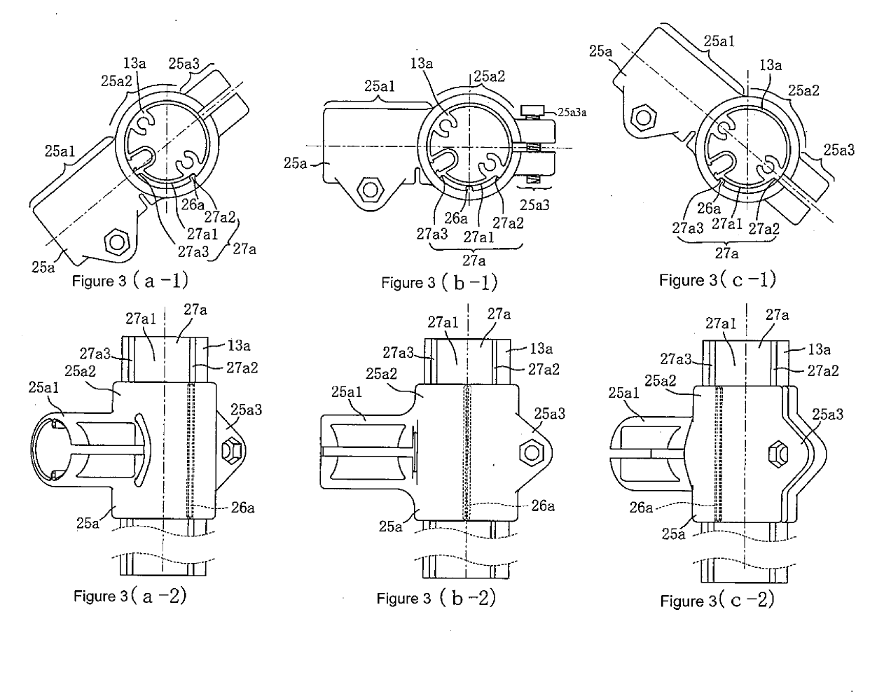

With reference to FIGS. 3(a-1) to 3(c-2), examples of joint components 25a, 25b and 24 are described. FIGS. 3(a-1) to 3(c-2) are diagrams of the connection between the joint component 25a and the center pipe 13a. Because the joint components 25a, 25b and 24 are identical, only the joint component 25a is fully explained, where the explanation applies equally well to joint components 25b and 24.

In the illustrations in FIGS. 3(a-1) and 3(a-2), the joint component is shown as if the drum pads 30a and 31a, cymbal pad 32a are placed in a first position. In the illustrations of FIGS. 3(c-1) and 3(c-2), the joint component is shown as if the drum pads 30a and 31a and cymbal pad 32a are placed in a second, different position. In the illustrations of FIGS. 3(b-1) and 3(b-2), the joint component is shown as if the drum pads 30a and 31a and cymbal pad 32a are placed in a middle position, between the positions shown in FIGS. 3(a-1), 3(a-2), 3(c-1) and 3(c-2).

FIG. 3(a-1) shows the joint component 25a and its relationship to the center pipe 13a. The joint component 25a is also connected to the pipe 20a (or the pipe 23a), as shown at 25a1. The attachment of the joint component 25a to the center pipe 13a is shown at 25a2 and a further attachment for securing the joint component to the center pipe 13a is shown at 25a3.

Once the joint component 25a1 is rotated around the axis of the center pipe 13a to adjust the arm pipes 20a and 23a in proper angle of alignment, the position can be locked down with a tightening of a screw 25a3a and the arm pipes 20a and 23a will be locked into place relative to the center pipe 13a.

The setting of the vertical hold height between attachment position 25a3 and pipes 20a and 23a can be accomplished as explained above, by tightening a screw (not shown) to lock in place the pipes 20a and 23a, once the optimal height has been selected. The joint components 25a keep the arm pipes 20a and 23a secure along the center pipe 13a.

The interior of the connector piece 25a3 (illustrated in FIG. 3(a-1)) on center pipe 13a) has a protrusion 26a extending toward the axis of the center pipe 13a within the center of the connector portion 25a3. Also the exterior surface of the center pipe 13a (the surface facing the joint component 25a) has a groove 27a.

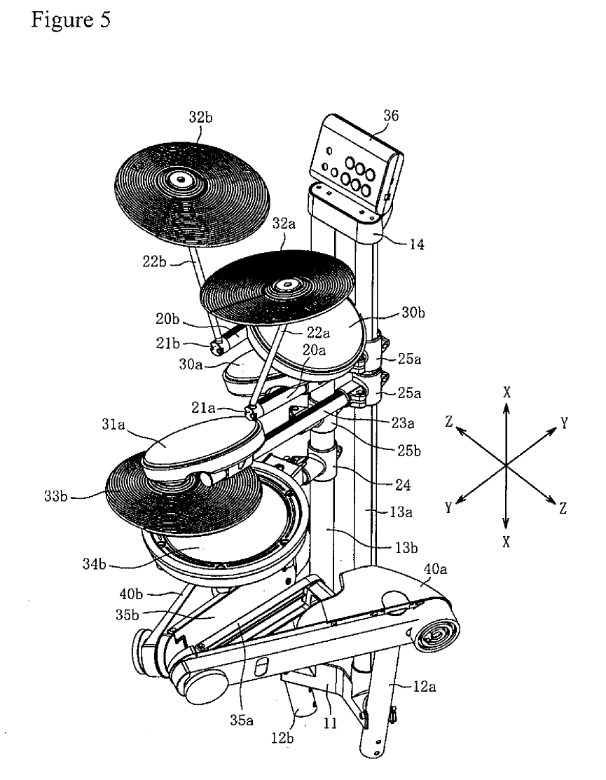

The joint component 25 is regulated in its movements around the axial direction of the center pipe by the groove 27a and protrusion 26a. The groove 27a is provided along the lengthwise dimension of the center pipe and is bordered by groove end walls 27a2 and 27a3 and surface 27a1. The axial movement of the joint component 25 relative to the center pipe 13a allows the protrusion 26a on the joint component 25a to move between the groove end walls 27a2 and 27a3. Protrusion 26a also regulates vertical movement along the center pipe 13a (where FIG. 5 shows the extent of the movement placed on the center pipe 13a by the protrusion 26a). Part 27a1 is the groove between end walls 27a2 and 27a3 in the center pipe 13a.

FIGS. 3(a-1) and 3(a-2) show the effect upon the possible positioning (position settings) of drum equipments using a stand according to embodiments of the invention, and the possible range of motion available to an artist in their performance using this stand based on the adjustability range of the joint component 25a.

FIGS. 3(c-1) and 3(c-2) show possible positions for easy transport and collapse of the electronic percussion instrument stand system 1 0 and the position (collapsed positions) which each component could be moved to, including the drum pads 30a, 31a and the cymbal pads 32a, in order to accommodate easy transportation. In the illustration, the joint component 25a has been moved along the groove 27 in the center pipe 13a, to the groove end wall 27a3.

Embodiments of the electronic percussion instrument stand may be designed so that it becomes very simple and easy to move the musical components drum pads 30a and 31a and cymbal pads 32a from their basic position to their playing position by simply moving the joint component 25a such that the protrusion 26a moves along the groove 27a between the end walls 27a2 and 27a3.

Also shown in FIG. 3(b-1) and 3(b-2) is the ease with which one can change the various position settings by simply moving joint component 25a such that the protrusion 26a moves along the groove 27a. In this way, because almost any position is possible, the artist can select whichever position suits the artist best for the drum pads 30a and 31a as well as the cymbal pads 32a.

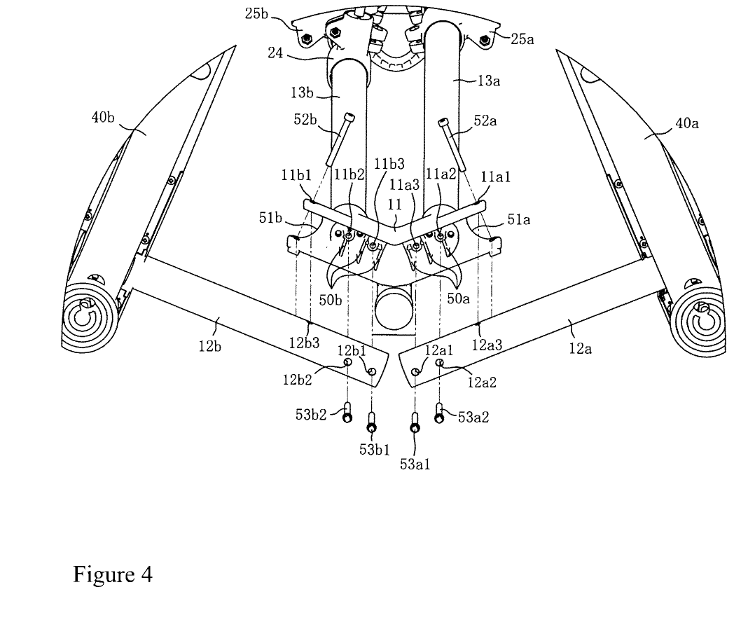

With reference to FIG. 4, the base section 11 and its connection with the two pipes 12a and 12b are described. FIG. 4 is a diagram drawing of the interrelation between the base 11 and the two pipes 12a and 12b.

FIG. 4 shows vertical channels through the pipes 12a and the first section 12a1 as well as vertical channels through the second section of the pipe 12a2 and the final level channel through the third section of pipe 12a3. As with pipe 12a, pipe 12b has the same structure and thus the vertical channels are shown through the pipe 12b and the first section 12b 1 as well as the vertical channels through the second section of the pipe 12b2 and the final level channel through the third section of pipe 12b3.

The base 11 is formed in the shape of a partial circle or crescent shape (semi-circle or “C” shape), on the horizontal plane. The channel 11a1 extends through one side (the right side of FIG. 4) of the base 11 and the channel 11b1 extends through the other side (the left side of FIG. 4) of the base 11. Also from the interior of the base (on right side of FIG. 4) can been seen the two threaded portions 11a2 and 11a3 for receiving screws. From the other side (left side of FIG. 4) can be seen the interior of the base 11 and the two threaded portions 11b2 and 11b3 for receiving screws.

In the illustrated embodiment, the base component 11 has a generally half circle or crescent shape but it is also possible to give this piece a C shaped structure. Other shapes are possibilities for this piece.

By joining the base 11 with the pipe 12a, the alignment is such that the third channel 12a3 in the pipe 12a is aligned with the channel 11a1 in the base component, and a shaft 52a extends through the third channel to connect the base 11 and the pipe 12a. The screws 53a1 and 53a2 align with and connect with the first and second channels 12a1 and 12a2, respectively and screw into threaded portions 11a3 and 11a2 through the first and second channels 12a1 and 12a2, respectively.

Similarly, the base 11 is connected to the pipe 12b, where screws 53b1 and 53b2 screw into threaded portions 11b3 and 11b2, through the second channels 12b1 and 12b2 in the pipe 12b.

By removing the screws 53a1, 53a2, 53b1 and 53b2, it is possible to rotate the pipes 12a and 12b relative to the base unit, along the shafts 52a and 52b. However the pipes 12a and 12b remain attached to the base 11.

If screws are removed from the base 11, the base will reveal three protrusions 50a and a U shaped opening 51a. Protrusion 50a may be included to provide strength and adjustability to the electronic percussion instrument stand (in order that when the center pipes 13a and 13b are supporting full weight that they will maintain structurally cohesive). To adjust the pipe 12a when the pipe 12a is in an extended position or when the electronic percussion instrument stand 10 is placed in a transport position (in a vertically integrated position with all components retracted) the U shaped opening 51a allows pipe 12a to be pivoted to a greater extent relative to the base 11.

Also on the inside of the base 11 there are two screws 11b2 and 11b3 as well as three protrusions 50b. The base on its edge facing the pipe 12b can have a U shaped opening similar to the edge facing the pipe 12a.

On the exterior of pipes 12a and 12b the protrusions 50a and 50b are lined up with the grooves 51a and 51b. To aid in repositioning or packing the electronic percussion instrument stand 10 for transport, pipes 12a and 12b (and leg component 40a and 40b) have been designed to move easily and be easy locked in a collapsed or folded state.

FIG. 5 illustrates a position and procedures for readying the electronic percussion instrument stand unit 10 for transportation. FIG. 5 shows the electronic percussion instrument stand 10 in its transportation configuration.

In order to most efficiently configure the electronic percussion stand 10 for transportation, the bolts 25a3 and 25b3 may be loosened and the components may be slid along the various grooves (as shown in FIGS. 1 and 2 along the direction of the B arrows). Then the joint unit is rotated so that the position of protrusions 26a and 26b abut with the groove end walls 27a3 and 27b3 and the joint unit collapses along the opened pathway. Then the screws (not shown) may be re-tightened. When moving the joint components, the various musical components, drum pads 31a, 30a and 30b, cymbal pad 32a, high hat cymbal 33b, and the snare pad 34b, may be moved so that they do not hit against each other or the stand apparatus. An example of a proper positioning for all of these components is shown in FIG. 5.

Next, the electronic percussion instrument stand 10 may be laid down and the screws 53a1, 53a2, 53b1 and 53b2 may be tightened. The pipe 12a may be positioned against the center pipes 13a and 13b as shown in FIGS. 1 and 2 (along the direction of arrow A), to prepare the electronic percussion instrument stand 10 for travel.

As shown in FIG. 5, once the electronic percussion instrument stand has been set for travel, all of the components may be parallel to each other and it should be possible to carry it as one piece. Also, the stand has also become much more compact (the overall size having decreased and been compacted). Because it is possible to carry the electronic percussion stand in a single, compact piece, it is can be easy and convenient to carry the electronic percussion instrument system. Also because the foot pedals 35a and 35b are part of the electronic percussion stand unit 10 there is no need for a separate carrying case for the foot pedals 35a and 35b or to have to reset the positioning when the stand is set up again. And finally, because the electronic percussion instrument stand need not be broken down into multiple pieces for transport, the stand stays together as a single unit and can be relatively simple to reassemble and also to carry.

Because the installation components 25a and 25b have been moved along the grooved paths 27a3 and 27b3 against the protrusions 26a and 26b, the musical components, drum pads 30a 30b 31a, cymbal pad 32a, high hat cymbal pad 33b, snare pad 34b are all in position and can be very rapidly brought into alignment and playing position once the unit is set up again. Also pipes 12a and 12b, components 51a and 51b are repositioned as well as the base 11 and the foot components 40a and 40b are all retracted into a compact mass which makes the carrying and lifting of the unit relatively simple.

Reassembly can be a relatively simple operation, by simply reversing the process above. Reassembly can be effected by sliding installation components 25a and 25b back from the protrusions 26a and 26b then sliding them up the grooves 27a2 and 27b2. Then, it will not only be very simple to reposition the drum pads 30a 30b 31a, cymbal pad 32a, high hat cymbal pad 33b, and snare pad 34b, but by extending pipes 12a and 12b as well as the stand 11 and the protrusions 50a and 50b then the leg components 40a and 40b, the entire electronic percussion instrument stand unit 10 can be ready to play in mere moments.

We have endeavored in the above explanation of example embodiments of this invention, to show how such embodiments functions as well as the versatility of the design.

In the above presented design and illustrations, the stand embodiment includes twin center pipes 13a and 13b. However, in other embodiments, a single pipe could function in place of the two pipes 13a and 13b. In yet other embodiments, more than two center pipes may be used. With a design which incorporated only a single center pipe, it may not be practical to accommodate all of the above mentioned components; drum pads 30a 30b 31a, cymbal pad 32a, high hat cymbal pad 33b, snare pad 34b. However, by using some, but not all of those components, a single center pipe configuration may be suitable. If more than two center pipes are used, more musical components may be used and supported by the stand.

What is claimed is:

1. An electronic percussion instrument stand comprising:
a center pipe structure including at least one center pipe having a longitudinal axis;
a base structure for supporting the center pipe structure in an upright orientation;
at least one first arm for supporting at least one electronic percussion instrument;
a first leg portion having a first foot pedal connected to the base structure.

2. An electronic percussion instrument stand as recited in claim 1, wherein the leg portion is connected to the base structure by a pivotal link, allowing the leg portion to pivot relative to the base structure.

3. An electronic percussion instrument stand as recited in claim 1, wherein the leg portion is foldable with the foot pedal.

4. An electronic percussion instrument stand as recited claim 1, further comprising at least one first joint for connecting the at least one first arm to the center pipe structure, each joint being adjustable in a direction of the longitudinal axis of the center pipe and in a direction around the longitudinal axis of the center pipe, for adjusting the position of the at least one first arm.

5. An electronic percussion instrument stand as recited in claim 4, wherein each joint is adjustable between a position for playing electronic percussion instruments supported on the at least one arm, to a retracted position for transportation.

6. An electronic percussion instrument stand as recited in claim 4, further comprising a second joint for connecting a further percussion instrument directly to the center pipe of the center pipe structure, the second joint being adjustable in a direction of the longitudinal axis of the center pipe and in a direction around the longitudinal axis of the center pipe, for adjusting the position of the further percussion instrument.

7. An electronic percussion instrument stand as recited in claim 1, wherein the base structure supports the center pipe structure with the longitudinal axis arranged generally vertically.

8. An electronic percussion instrument stand as recited in claim 1, further comprising:
a first leg pipe and a second leg pipe connected to and extending in mutually opposed directions from the base structure;
the first leg portion having a first foot pedal connected to the first leg pipe;
a second leg portion having a second foot pedal is connected to the second leg pipe.

9. An electronic percussion instrument stand as recited in claim 8, wherein the first leg pipe is connected to the base structure by pivotal link, allowing the first leg pipe to pivot relative to the base portion and wherein the second leg pipe is connected to the base structure by pivotal link, allowing the second leg pipe to pivot relative to the base portion.

10. An electronic percussion instrument stand as recited in claim 9, wherein the first leg pipe is pivotal about an axis that is generally perpendicular to the longitudinal dimension of the center pipe.

11. An electronic percussion instrument stand as recited in claim 7, wherein:
the center pipe structure comprises first and second center pipes, each center pipe having a longitudinal axis;
the base structure supports each of the center pipes in an upright orientation; and
the stand further comprising at least one second arm and at least one second joint, the at least one second joint connecting the at least one second arm to the second center pipe, each second joint being adjustable in a direction of the longitudinal axis of the second center pipe and in a direction around the longitudinal axis of the second center pipe, for adjusting the position of the arm.

12. An electronic percussion instrument stand as recited in claim 1, wherein the base has a generally crescent shape.

13. An electronic percussion instrument stand as recited in claim 12, further comprising a first leg pipe extending from a first end of the crescent shaped base and a second leg pipe extending from a second end of the crescent shaped base.

14. An electronic percussion instrument stand as recited in claim 13, further comprising a leg portion having a first foot pedal connected to the first leg pipe, and a second leg portion having a second foot pedal connected to the second leg pipe.

15. An electronic percussion instrument and stand comprising:
a center pipe structure including at least one center pipe having a longitudinal axis;
a base structure for supporting the center pipe structure in an upright orientation;
at least one first arm;
a plurality of electronic percussion instruments supported by the at least one first arm;
at least one first joint for connecting the at least one first arm to the center pipe structure, each joint being adjustable in a direction of the longitudinal axis of the center pipe and in a direction around the longitudinal axis of the center pipe, for adjusting the position of the at least one first arm.

16. An electronic percussion instrument and stand as recited in claim 15, wherein each joint is adjustable between a position for playing the electronic percussion instruments supported on the at least one arm, to a retracted position for transportation.

17. An electronic percussion instrument stand as recited in claim 15, wherein:
the center pipe structure comprises first and second center pipes, each center pipe having a longitudinal axis;
the base structure supports each of the center pipes in an upright orientation;
the stand further comprising at least one second arm and at least one second joint, the at least one second joint connecting the at least one second arm to the second center pipe, each second joint being adjustable in a direction of the longitudinal axis of the second center pipe and in a direction around the longitudinal axis of the second center pipe, for adjusting the position of the arm; and
at least one further percussion instrument supported by the second arm.
